(19) United States
(12) Patent Application Publication
(10) Pub. No.: US 2022/0301024 A1
(43) Pub. Date: Sep. 22, 2022

(54) SEQUENTIAL RECOMMENDATION METHOD BASED ON LONG-TERM AND SHORT-TERM INTERESTS

(71) Applicant: Northwestern Polytechnical University, Xi'an (CN)

(72) Inventors: Bin Guo, Xi'an (CN); Yan Zhang, Xi'an (CN); Qianru Wang, Xi'an (CN); Jing Zhang, Xi'an (CN); Zhiwen Yu, Xi'an (CN)

(21) Appl. No.: 17/727,727

(22) Filed: Apr. 23, 2022

Related U.S. Application Data
(63) Continuation of application No. PCT/CN2020/110549, filed on Aug. 21, 2020.

(30) Foreign Application Priority Data
Jan. 7, 2020 (CN) 202010014762.2

(51) Int. Cl. G06Q 30/02

(52) U.S. Cl. CPC G06Q 30/0282; G06Q 30/0201

(57) ABSTRACT

This disclosure provides a sequential recommendation method based on long-term and short-term interests, in which an interaction sequence between a user and products is obtained by processing a purchase sequence of the user and a question data of the user in a dataset, characteristics of the products are represented with extracted comments of the user on the products; next, a stable long-term preference of the user is learned from a historical purchase sequence of the user with a recursive neural network, and immediate interests of the user are modeled with the question data. For the stable long-term preference and dynamic immediate interests, a dependence of different users on the two characteristics is described with an Attention mechanism, so as to effectively solve a problem of an inaccurate recommendation caused by an evolution of the preference of the user, while different dependence degrees of the different users on the long-term preference and immediate interests can represented effectively.

### CROSS-REFERENCE TO RELATED APPLICATION(S)

This application claims priority to and the benefit of Chinese Patent Application Serial No. 202010014762.2, filed Jan. 7, 2020, the entire disclosure of which is hereby incorporated by reference.

### TECHNICAL FIELD

This disclosure relates to sequential recommendation and a recommendation system based on deep learning, in particular to a sequential recommendation method based on long-term and short-term interests.

### BACKGROUND

As an important part of modern e-commerce websites, a recommendation system tries to recommend products that users want to buy or interact according to their interests or preferences. With a development of an e-commerce mechanism, numerous user interactions (such as browsing, clicking, collecting, putting into shopping cart, purchasing) are recorded, in which consumption patterns of the users are hidden deeply. These logs with sufficient information provide a data base for a study of users' preferences and personalized recommendations.

Modeling of interactions between users and products in an existing recommendation system can be classified into two main methods. The first method is to obtain preferences of the user with collaborative filtering based on matrix decomposition. The method focuses on mining static association between the user and products, which is represented with a traditional collaborative filtering model. However, it only considers a specific relationship between the users and products from a static view, ignoring an evolution of the user preferences implied in an sequential interaction, and an impact of the evolution on future purchasing of the products.

The second method is to mine the relationship between the user and products based on a sequential pattern, so as to make a personalized recommendation. A stable long-term preference of the user is a preference caused by personal habits for a long time, and a short-term preference is a preference determined by the products recently purchased by the user. The method includes modeling the sequential interaction between the user and products according to a Markov chain model and a RNN model.

Although existing sequence models can predict the products that the user may buy in a next purchase based on an interaction behavior sequence, they have following two shortcomings: firstly, these

methods focus on representing a relationship between the products directly with a sequence between the products, an product vector represented directly with a similarity between the products cannot directly represent the preferences of the user since different users pay different attention to different aspects when purchasing the same product; and secondly, the existing models ignore immediate interests of the user, which are different from the short-term preference, the immediate interests are immediate and specific demands when the user want to buy an product or a series of products.

### SUMMARY

In view of the above drawbacks, this disclosure provides a sequential recommendation method based on long-term and short-term interests. Technical schemes of the disclosure are as follows.

A sequential recommendation method based on long-term and short-term interests is provided, which comprises following steps:

S1: acquiring data and preprocessing the data;

S2: processing all of comment texts and question texts, selecting words with highest scores from relevant texts of each of products as extraction characteristics, describing the products with a collection of all of the characteristics, and constructing a characteristic representation matrix of the products;

S3: constructing a vector representation of a purchase sequence of a user, obtaining a vector representation of the purchase sequence of the user from the characteristic representation matrix of the products and a historical purchase sequence of the user;

S4: representing the long-term interests and short-term interests of the user respectively;

S5: aggregating the long-term interests and short-term interests of the user with an Attention mechanism, so as to obtain an aggregated preference of the user;

S6: determining a relationship between the aggregated preference and a target product, so as to obtain a probability of an interaction of the user with the product after questioning;

S7: learning parameters of a sequential recommendation model with a cross entropy loss function, so as to obtain a probability of each of the products purchased after questioning.

Further, in the sequential recommendation method, the preprocessing in S1 includes ranking the purchase data, comment data and question data of each of the users in a time order, and filtering the users with low total purchases.

Further, in the sequential recommendation method, a number of the words with the highest scores selected in S2 is greater than or equal to 5.

Further, in the sequential recommendation method, the comment texts and question texts in S2 are processed with a TF-IDF method.

Further, in the sequential recommendation method, the long-term interests of the user is represented with a value of a bi-directional RNN hidden unit according to the vector representation of the purchase sequence of the user.

Further, in the sequential recommendation method, the question texts of the user at a certain moment is processed with a CoreNLP algorithm of the short-term interest preference, so as to obtain the score of the characteristics to which the user pays more attention in questioning, then the short-term interest preference of the user can be represented.

Further, in the sequential recommendation method, the relationship between the aggregated preference and target product in S6 is determined with a fully connected layer.

The method has following advantages: the long-term preference of the user can be modeled from the historical interaction sequence between the user and the products with a recursive neural network; the immediate interests of the user can be extracted from the questions of the user about the products; the long-term preference and immediate interests can be aggregated based on the Attention mechanism, so as to make a personalized recommendation for the user at next moment. It can effectively solve a problem of inaccurate recommendation caused by an evolution of the preference of the user, meanwhile it can effectively represent a different dependence of different users on the long-term preference and immediate interests.

### BRIEF DESCRIPTION OF THE DRAWINGS

FIG. 1 is a flow chart of a sequential recommendation method based on long-term and short-term interests;

FIG. 2 is a diagram of a model of the sequential recommendation method based on long-term and short-term interests;

FIG. 3 shows a change of recommendation performance of Recall and HR with a length of a recommendation list in the sequential recommendation method;

FIG. 4 shows a dependence of different users on the long-term preference and immediate interests in the sequential recommendation method.

### DETAILED DESCRIPTION

Technical schemes of the present disclosure will be further described in the following with reference to the drawings.

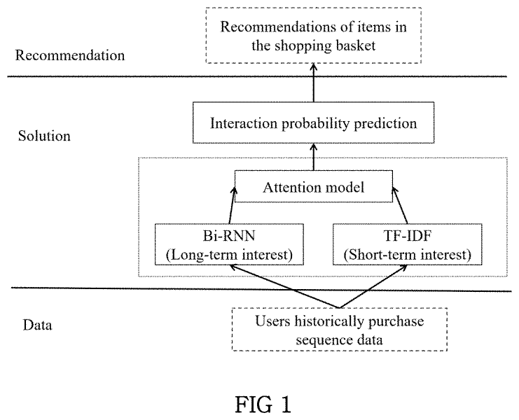

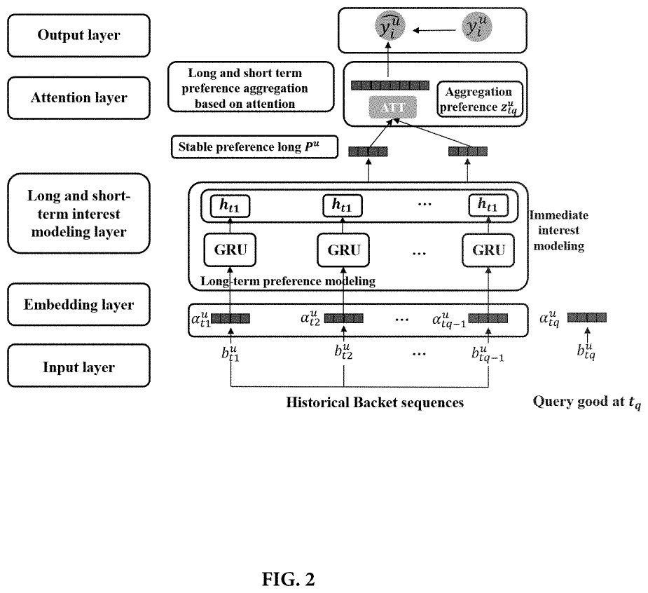

As shown in FIG. 1, an interaction sequence between a user and products is obtained by processing a purchase sequence of the user and a question data of the user in a dataset, characteristics of the products are represented with extracted comments of the user on the products; next, a stable long-term preference of the user is learned from a historical purchase sequence of the user with a recursive neural network, and immediate interests of the user are modeled with the question data. For the stable long-term preference and dynamic immediate interests, a dependence of different users on the two characteristics is described with an Attention mechanism. The method comprises following steps S1 to S7, as shown in FIG. 2.

In step S1, data is acquired and preprocessed.

According to a general data processing mode, the preprocessing includes ranking the purchase data, comment data and question data of each of the users in time order, and filtering the users with low total purchases. In order to ensure a recommendation accuracy, this embodiment filters out the users whose total purchases are less than 5.

In step S2: the comment texts and question texts are processed with a TF-IDF method.

k words with the highest scores are selected from relevant texts of each product as extracted characteristics, and the commodity is described with a set A={a₁, a₂, . . . , aₖ} of all characteristics, which is represented as I={i₁, i₂, . . . , iₙ}, wherein iⱼ is a characteristic representation of the j-th product.

In step S3: a vector representation for the purchase sequence of the user is constructed.

From a characteristic representation matrix I of the product and the historical purchase sequence of the user, the vector representation of the purchase sequence of each user is obtained and represented as:

B_{<t}_{_{q}}^{u}={bₜ_{₁}^{u},bₜ_{₂}^{u}, . . . ,bₜ_{_{q−1}}^{u}|bₜ_{ⱼ}⊂I,bₜ_{ⱼ}∈R^{|I|}}

where, bₜ_{ᵢ}^{u} is a vector representation of the products purchased by user u at moment tᵢ;

In step S4, the long-term interests of the user is represented.

The long-term preference of the user is represented with a value of a bi-directional RNN hidden unit according to the vector representation B_{<t}_{_{q}}^{u} of the purchase sequence of the user, with following formula

iⱼ=δ(Wᵥᵢbⱼ+Wₕᵢhⱼ₋₁+W_{ci}cⱼ₋₁+ [symbol] ),

fⱼ=δ(W_{vf}bⱼ+W_{hf}hⱼ₋₁+W_{cf}cⱼ₋₁+ [symbol] ),

cⱼ=fⱼcⱼ₋₁+iⱼ tanh(W_{vc}bⱼ+W_{hc}hⱼ₋₁+ [symbol] ),

oⱼ=δ(Wᵥₒbⱼ+Wₕₒhⱼ₋₁+W_{co}cⱼ+ [symbol] ),

hⱼ=oⱼ tanh(cⱼ)

where, iⱼ, fⱼ and oⱼ respectively corresponds to an input gate, a forget gate and an output gate of GRU, bⱼ is a vector representation of a shopping basket at present, cⱼ is a value of a memory unit of GRU, \hat{b} is an offset item, and hⱼ is a hidden state of j-th step; {right arrow over (hₜ_{_{q}})} and [symbol] respectively indicates a value of the hidden unit obtained with forward and backward RNN, hₜ_{_{q}} is obtained by splicing them together, so the long-term interests of the user u is represented as:

longP^{u}=average(h₁,h₂, . . . ,h_{tq});

In step S5, the short-term preference of the user is represented.

In a short-term preference model, a CoreNLP algorithm is used to process the question text of the user at moment t_{q} to obtain a score of the characteristics to which the user pays more attention in the question, so the short-term preference of the user u may be described as:

shortP^{u}=[Scoreₐ_{₁},Scoreₐ_{₂}, . . . ,Scoreₐ_{ₖ}]

where, Scoreₐ_{ᵢ} indicates a emotion score of the aᵢ-th characteristic, which is a dependence of the user u on the aᵢ-th characteristic at the question moment t_{q}.

In step S6, from the long-term preference obtained from S4 and the short-term preference obtained from S5, the aggregated preference of the user combining the long-term and short-term interests may be obtained with an Attention mechanism.

The aggregated preference is represented as:

zₜ_{_{q}}^{u}=β[longP^{u},shortP^{u}]

A relationship between the aggregated preference and target products is found with a fully connected layer, and a probability ŷ^{u} of an interaction with the products after the user u questioning is represented as:

ŷ^{u}=sigmoid(Wz^{u}^{^{T}}+b);

In Step S7, parameters of the model is learned with a cross entropy loss function to obtain a probability of each product purchased after the questioning moment t_{q}, the probability is represented as:

$$L = - {\sum }_{( u , i ) ϵγ ⋃ {γ}^{-}} {y}_{i}^{u} log - ( 1 - {y}_{i}^{u} ) log ( 1 - )$$

wherein, γ indicates observed items in the historical purchase sequence, and γ⁻ indicates negative instance, all of the products not observed can be regarded as the negative instances, or negative sampling can be employed.

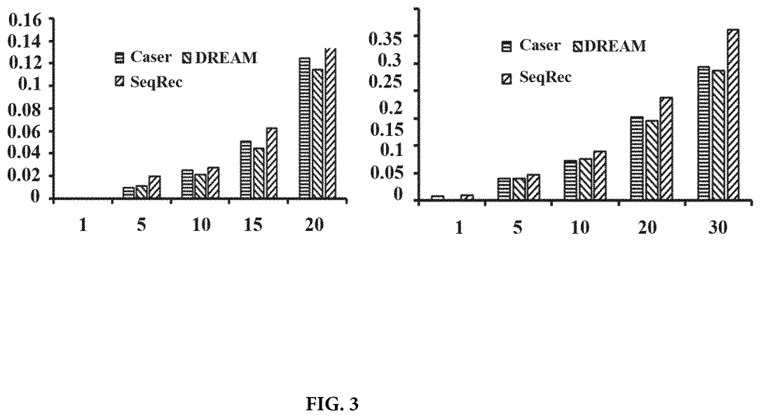

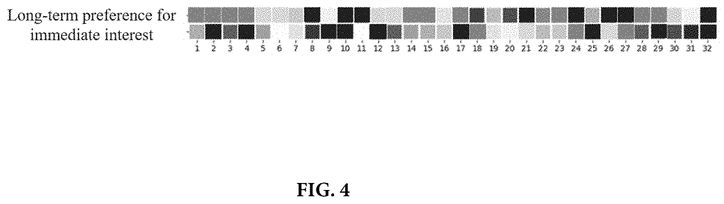

The recommendation results of the method are shown in FIGS. 3 and 4, a vector of a prediction score is obtained by predicting the products that the user may buy at a next moment, thus recommending top-K products to the user.

What is claimed is:

1. A sequential recommendation method based on long-term and short-term interests, comprising following steps:
S1: acquiring data and preprocessing the data;
S2: processing all of comment texts and question texts, selecting words with highest scores from relevant texts of each of products as extraction characteristics, describing the products with a collection of all of the characteristics, and constructing a characteristic representation matrix of the products;
S3: constructing a vector representation of a purchase sequence of a user, obtaining a vector representation of the purchase sequence of the user from the characteristic representation matrix of the products and a historical purchase sequence of the user;
S4: representing the long-term interests and short-term interests of the user respectively;
S5: aggregating the long-term interests and short-term interests of the user with an Attention mechanism, so as to obtain an aggregated preference of the user;
S6: determining a relationship between the aggregated preference and a target product, so as to obtain a probability of an interaction of the user with the product after questioning; and
S7: learning parameters of a sequential recommendation model with a cross entropy loss function, so as to obtain a probability of each of the products purchased after questioning.

2. The method according to claim 1, wherein the preprocessing in S1 comprises ranking the purchase data, comment data and question data of each of the users in a time order, and filtering the users with low total purchases.

3. The method according to claim 1, wherein a number of the words with the highest scores selected in S2 is greater than or equal to 5.

4. The method according to claim 1, wherein the comment texts and question texts in S2 are processed with a TF-IDF method.

5. The method according to claim 1, wherein the long-term interests of the user is represented with a value of a bi-directional RNN hidden unit according to the vector representation of the purchase sequence of the user.

6. The method according to claim 1, wherein the question texts of the user at a certain moment is processed with a CoreNLP algorithm of the short-term interest preference, so as to obtain the score of the characteristics to which the user pays more attention in questioning, then the short-term interest preference of the user can be represented.

7. The method according to claim 1, wherein the relationship between the aggregated preference and target product in S6 is determined with a fully connected layer.
